(19) United States
(12) Patent Application Publication
(10) Pub. No.: US 2026/0219376 A1
(43) Pub. Date: Jul. 30, 2026

(54) PROCESSING SYSTEM, TEACHER DATA GENERATING METHOD, AND OBJECT DETECTION METHOD

(71) Applicant: NEC Corporation, Tokyo (JP)

(72) Inventors: Jianquan LIU, Tokyo (JP); Eiji MURAMATSU, Tokyo (JP)

(73) Assignee: NEC Corporation, Tokyo (JP)

(21) Appl. No.: 19/146,089

(22) PCT Filed: Feb. 13, 2024
(86) PCT No.: PCT/JP2024/004802

§ 371 Date: Jul. 7, 2025

(30) Foreign Application Priority Data
Mar. 30, 2023 (JP) 2023-055109

(51) Int. Cl. G01S 13/46

(52) U.S. Cl. CPC G01S 13/46

(57) ABSTRACT

According to the present invention, a flying body comprises an electromagnetic wave emitting unit and a reflected wave detecting unit. The electromagnetic wave emitting unit emits electromagnetic waves toward a target region. The reflected wave detecting unit detects reflected waves of the electromagnetic waves and generates reflected wave data. The processing system according to the present invention comprises a data acquiring unit, a three-dimensional information generating unit, and a detecting unit. The data acquiring unit acquires the reflected wave data generated by the flying body. The three-dimensional information generating unit uses the reflected wave data to generate three-dimensional information. The three-dimensional information includes the position of a reflection point in three-dimensional space and the probability that an object exists at the reflection point. The detecting unit detects the type of the object and the position of the object in three-dimensional space by processing the three-dimensional information using a trained model.

### TECHNICAL FIELD

The present invention relates to an object detection system, a processing system, a teacher data generating method, an object detection method, and a recording medium.

### BACKGROUND ART

As a device configured to detect an object buried in the ground, for example, there is a device described in PTL 1. This device is a device configured to detect a landmine. Specifically, a sensor head is provided with a transmission unit and a reception unit. The transmission unit transmits an impulse of an electromagnetic wave toward the ground where a landmine is to be detected, and the reception unit receives a reflected wave from the landmine. Then, the device generates information indicating a three-dimensional structure of the landmine based on a time until the reflected wave is received, a reception level of the reflected wave, and a position of the sensor head, and displays the information on a display unit.

PTL 2 discloses the following distance measuring system. First, the distance measuring system includes a plurality of distance measuring devices and a storage device. The plurality of distance measuring devices include a LiDAR sensor and one or more other distance measuring devices. In addition, the storage device stores three-dimensional point cloud data based on the distance measurement data acquired by each of the plurality of distance measuring devices. The LiDAR sensor includes a light emitting device capable of changing an exiting direction of a light beam, a light receiving device configured to detect reflected light by the light beam and output a signal indicating a detection result, and a processing circuit configured to control the light emitting device and the light receiving device and generate distance measurement data based on the signal output from the light receiving device. The processing circuit refers to the point cloud data to determine one or more blank regions of the point cloud data, and causes the light emitting device to exit the light beam toward the blank region, thereby measuring a distance of the blank region.

Furthermore, PTL 3 discloses a recognition processing system. The recognition processing system includes a first sensor device configured to acquire an image signal by imaging, a second sensor device configured to perform object detection process, a selecting unit for selecting one of a plurality of recognition processes based on information of the detected object, and a recognition processing unit for executing the selected recognition process based on the image signal.

Furthermore, PTL 4 discloses a braking assistance control device of a vehicle. The braking assistance control device acquires information of a periphery of an own vehicle from a detector provided in the vehicle, and determines a dead angle region in an opposite lane of an intersection using the acquired information of the periphery of the own vehicle. Then, in response to determining that an obstacle is present in the dead angle region while the vehicle is making a turn at the intersection, the braking assistance control device causes the braking assistance device of the vehicle to execute the braking assistance by an intersection braking assistance level different from a reference braking assistance level executed for collision avoidance.

### CITATION LIST

### Patent Literature

PTL 1: WO 2000/023762 A1
PTL 2: WO 2022/153653 A1
PTL 3: WO 2021/186960 A1
PTL 4: WO 2020/184287 A1

### SUMMARY OF INVENTION

### Technical Problem

In the case of using the technique described in PTL 1 described above, in a case where the region to be investigated is a wide region, a large amount of labor is required to investigate the entire region. This problem cannot be solved even by using the techniques described in PTLs 2 to 4. In view of the above-described problems, an object of the present invention is to provide an object detection system, a processing system, a teacher data generating method, an object detection method, and a recording medium that require less labor at the time of investigation even in a case where a region to be investigated is a wide region.

### Solution to Problem

According to one aspect of the present invention, there is provided an object detection system for detecting an object existing on a ground surface or in a ground of a target region, the object detection system including:
a flying body and a processing system, in which
the flying body includes
   an electromagnetic wave emitting means for emitting an electromagnetic wave toward the target region, and
   a reflected wave detecting means for detecting a reflected wave of the electromagnetic wave and generating reflected wave data, and
the processing system includes
   a data acquiring means for acquiring the reflected wave data,
   a three-dimensional information generation means for generating three-dimensional information including a position of a reflection point in a three-dimensional space and a probability that an object exists at the reflection point by using the reflected wave data, and
   a detecting means for detecting a type of the object and a position in the three-dimensional space by processing the three-dimensional information with a learned model.

According to one aspect of the present invention, there is provided a processing system for detecting an object existing on a ground surface or in a ground of a target region, the processing system including:
a data acquiring means for acquiring, from a flying body including an electromagnetic wave emitting means for emitting an electromagnetic wave toward the target region, and a reflected wave detecting means for detecting a reflected wave of the electromagnetic wave and generating reflected wave data, the reflected wave data,
a three-dimensional information generation means for generating three-dimensional information including a position of a reflection point in a three-dimensional space and a probability that an object exists at the reflection point by using the reflected wave data, and
a detecting means for detecting a type of the object and a position in the three-dimensional space by processing the three-dimensional information with a learned model.

According to one aspect of the present invention, there is provided a teacher data generating method for generating teacher data for generating a learning model by performing processes described in the following (1) to (7) for each of a plurality of types of objects.

(1) A depth from a ground surface is set, and the object is disposed at the set depth of a target region.

(2) A measurement device including an electromagnetic wave emitting means for emitting an electromagnetic wave and a reflected wave detecting means for detecting a reflected wave of the electromagnetic wave and generating reflected wave data is arranged above the target region.

(3) The electromagnetic wave is emitted toward the object from the electromagnetic wave emitting means, and the reflected wave detecting means is caused to generate the reflected wave data.

(4) The (3) is executed a plurality of times while differing an angle formed by the target region and the reflected wave detecting means.

(5) The (1), (2), (3), and (4) are performed a plurality of times while changing a set value of the depth.

(6) Three-dimensional information including a position of a reflection point in a three-dimensional space and a probability that an object exists at the reflection point is generated for each of the depth by processing the reflected wave data at a timing after the (4).

(7) The teacher data is generated with the three-dimensional information as an explanatory variable and the type and the depth of the object as objective variables.

According to one aspect of the present invention, there is provided an object detection method for detecting an object existing on a ground surface or in a ground of a target region, in which
the flying body,
   emits an electromagnetic wave toward the target region and detects a reflected wave of the electromagnetic wave to generate reflected wave data, and
the processing system,
   acquires the reflected wave data, and generates three-dimensional information including a position of a reflection point in a three-dimensional space and a probability that an object exists at the reflection point by using the reflected wave data, and
   detects a type of the object and a position in the three-dimensional space by processing the three-dimensional information with a learned model.

According to one aspect of the present invention, there is provided a computer readable recording medium recorded with a program for causing a computer to execute operations including:
acquiring, from a flying body including an electromagnetic wave emitting means for emitting an electromagnetic wave toward a target region, and a reflected wave detecting means for detecting a reflected wave of the electromagnetic wave and generating reflected wave data, the reflected wave data,
generating three-dimensional information including a position of a reflection point in a three-dimensional space and a probability that an object exists at the reflection point by using the reflected wave data, and
detecting a type of the object and a position in the three-dimensional space by processing the three-dimensional information with a learned model.

### Advantageous Effects of Invention

According to one aspect of the present invention, a labor required at the time of investigation can be reduced even in a case where a region to be investigated is a wide region.

### BRIEF DESCRIPTION OF DRAWINGS

FIG. 1 It is a diagram illustrating an outline of an object detection system according to an example embodiment.

FIG. 2 It is a diagram illustrating a detailed example of functions of a flying body.

FIG. 3 It is a diagram for explaining a method for detecting a reflected wave a plurality of times.

FIG. 4 It is a diagram for explaining a method for detecting a reflected wave a plurality of times.

FIG. 5 It is a diagram for explaining a method for detecting a reflected wave a plurality of times.

FIG. 6 It is a diagram illustrating a detailed example of functions of a processing system.

FIG. 7 It is a diagram for describing a method for creating teacher data used when generating a learned model to be used by a detecting unit.

FIG. 8 It is a diagram illustrating a hardware configuration example of a device constituting the processing system.

FIG. 9 It is a flowchart illustrating an example of a process performed by the processing system.

FIG. 10 It is a diagram illustrating a configuration of a processing system according to a first modified example.

FIG. 11 It is a diagram illustrating a configuration of the processing system according to the first modified example.

### EXAMPLE EMBODIMENT

Hereinafter, example embodiments of the present invention will be described with reference to the drawings. In all the drawings, similar components are denoted by similar reference numerals, and the description thereof will be omitted as appropriate.

### Example Embodiment

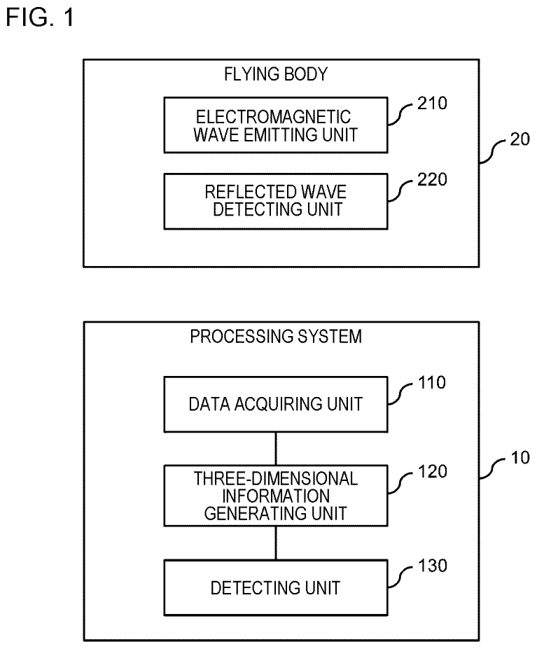

FIG. 1 is a diagram illustrating an outline of an object detection system according to an example embodiment. This object detection system is a system for detecting an object existing on the ground surface or in the ground of a target region, and includes a processing system 10 and a flying body 20.

The flying body 20 includes an electromagnetic wave emitting unit 210 and a reflected wave detecting unit 220. The electromagnetic wave emitting unit 210 emits electromagnetic waves toward a target region. The reflected wave detecting unit 220 detects a reflected wave of the electromagnetic wave and generates reflected wave data.

The processing system 10 includes a data acquiring unit 110, a three-dimensional information generating unit 120, and a detecting unit 130. The data acquiring unit 110 acquires the reflected wave data generated by the flying body 20. The three-dimensional information generating unit 120 generates three-dimensional information by using the reflected wave data. The three-dimensional information includes the position of a reflection point in three-dimensional space and the probability that an object exists at the reflection point. The detecting unit 130 detects the type of the object and the position of the object in a three-dimensional space by processing the three-dimensional information using a learned model.

According to this object detection system, the reflected wave data is generated by the flying body 20. Therefore, labor in generating the reflection data is reduced. In addition, the processing system 10 detects the type of the object and the position of the object in the three-dimensional space by processing the three-dimensional information with the learned model. Therefore, even if a large amount of noise is included in the reflected wave data, the type and position of the object can be accurately detected.

An example of the flying body 20 is a drone, but is not limited thereto. Furthermore, the reflected wave data generated by the flying body 20 may be transmitted from the flying body to the processing system 10 via, for example, near field communication, or may be transmitted from the flying body 20 to the processing system 10 via a removable medium.

The processing system 10 may be configured by one device or may be configured by a plurality of devices. In the latter case, the plurality of devices constituting the processing system 10 may be installed at locations different from each other. In this case, the plurality of devices may communicate with each other via a public communication network such as, for example, a mobile communication network.

Hereinafter, a detailed example of the object detection system will be described.

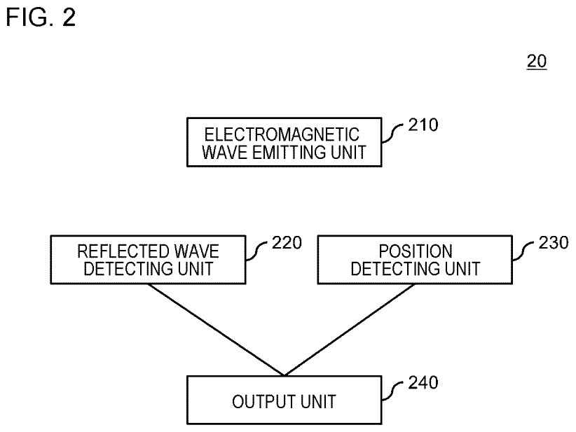

FIG. 2 is a diagram illustrating a detailed example of functions of the flying body 20. The flying body 20 can be remotely operated and moves automatically or by remote operation. In addition, the target region where the presence or absence of an object is to be investigated is, for example, the ground and the ground below the ground. The flying body 20 generates reflected wave data while moving in a region where the presence or absence of an object is to be investigated, and transmits the reflected wave data to the processing system 10 via, for example, wireless communication. This transmission is performed, for example, in real time, but may be performed in a batch manner.

The flying body 20 includes an electromagnetic wave emitting unit 210, a reflected wave detecting unit 220, a position detecting unit 230, and an output unit 240.

The electromagnetic wave emitting unit 210 emits electromagnetic waves toward a target region. The electromagnetic wave is, for example, a millimeter wave, and an example of a wavelength thereof is equal to or more than 0.3 GHz and equal to or less than 300 GHz. However, the band of the electromagnetic wave emitted by the electromagnetic wave emitting unit 210 is not limited to the millimeter wave. The transmission method used by the electromagnetic wave emitting unit 210 is, for example, any of frequency modulated continuous wave (FMCW), pulse, continuous wave (CW) Doppler, 2 frequency CW, and pulse compression, but may be other methods.

The reflected wave detecting unit 220 receives a reflected wave of the electromagnetic wave emitted by the electromagnetic wave emitting unit 210. This reflected wave is an electromagnetic wave reflected by, for example, an object on the ground surface or an object in the ground. In other words, if an object that reflects an electromagnetic wave exists in the target region, the intensity of the reflected wave increases. The object that reflects the electromagnetic wave is mainly formed of metal in many cases. Examples of such objects are, but are not limited to, unexploded bombs, grenades, landmines, and illegal disposals. Then, the reflected wave detecting unit 220 generates time-series information of the intensity of the detected reflected wave as reflected wave data. The time-series information includes a combination of the reception date and time of the reflected wave and the intensity of the reflected wave at that time.

When generating the reflected wave data, reflected wave detecting unit 220 detects the reflected wave a plurality of times while differing an angle formed by the target region and reflected wave detecting unit 220. A specific example for this will be described later with reference to other drawings.

The position detecting unit 230 generates position data indicating the position of the flying body 20. The position data is, for example, time-series information of the position of the flying body 20, and includes a combination of date and time and the position of the flying body at that date and time. This position data may be generated using, for example, GPS, or may be generated using another method, for example, simultaneous localization and mapping (SLAM).

The output unit 240 outputs the reflected wave data and the position data. As an example, the output unit 240 transmits the reflected wave data and the position data to the processing system 10 via wireless communication. This transmission may be performed in a batch manner or in real time as described above. Furthermore, the output unit 240 may output and store the reflected wave data and the position data in a removable medium.

Furthermore, the output unit 240 may have a function of receiving information from an external device. As an example, the output unit 240 receives information for controlling the movement of the flying body 20, for example, route information indicating a route to move. In this case, the movement control unit of the flying body 20 controls the movement mechanism of the flying body 20 to fly the flying body 20 according to the received route information. In a case where a sensor configured to detect an obstacle such as LiDAR or an imaging device is provided, the flying body 20 may fly while avoiding the obstacle.

The flying body 20 may be stationary in the air at the time of measurement. In this case, the flying body 20 may change a height when it is moving and a height when it is stationary. For example, the flying body 20 is located at an altitude of equal to or higher than m when moving, but may be located at an altitude of equal to or higher than 2 m and equal to or lower than 10 m when performing measurement while being stationary.

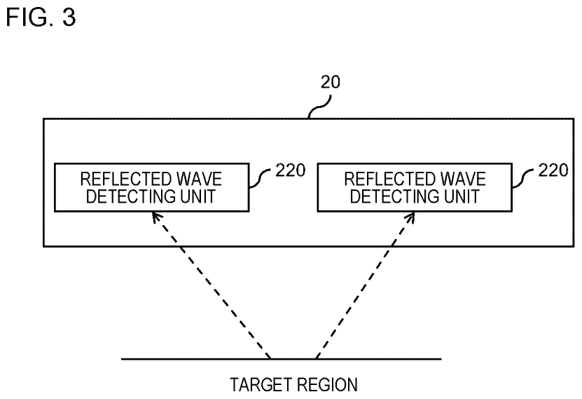

Each of FIGS. 3, 4, and 5 is a diagram for explaining a method for detecting the reflected wave a plurality of times while making the angle formed by the target region and the reflected wave detecting unit 220 different.

In the first method illustrated in FIG. 3, the flying body 20 includes a plurality of reflected wave detecting units 220. The plurality of reflected wave detecting units 220 detect the reflected wave of the electromagnetic wave emitted by the same electromagnetic wave emitting unit 210. Here, the plurality of reflected wave detecting units 220 are separated from each other. Therefore, by using the plurality of reflected wave detecting units 220, the reflected wave can be detected a plurality of times while differing the angle formed by the target region and the reflected wave detecting unit 220.

In the example illustrated in the figure, the flying body 20 is preferably stationary in the air when generating the reflected wave data.

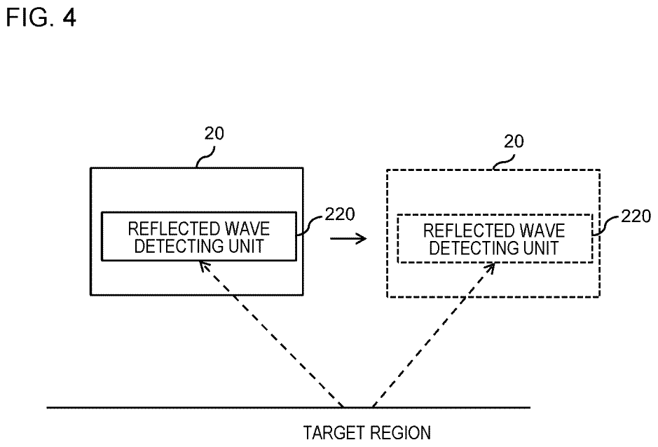

In the second method illustrated in FIG. 4, the flying body 20 is stationary in the air when generating the reflected wave data. In this state, the electromagnetic wave emitting unit scans the electromagnetic wave toward the ground. At this time, the flying body 20 moves the stationary position while gradually shifting the range scanned by the electromagnetic wave. Specifically, the flying body 20 divides a region to be investigated into a plurality of sub-regions. Each of the sub-regions is a region measured at one stationary position. The adjacent sub-regions overlap each other. That is, a part of the range scanned by the electromagnetic wave at a certain stationary position overlaps the range scanned by the electromagnetic wave at another stationary position. Each of the overlapping regions can be regarded as a target region. An angle formed by the flying body 20 and the target region at a certain stationary position is different from an angle formed by the flying body 20 and the target region at another stationary position. For this reason, the flying body 20 can detect the reflected wave a plurality of times while making the angle formed by the target region and the reflected wave detecting unit 220 different.

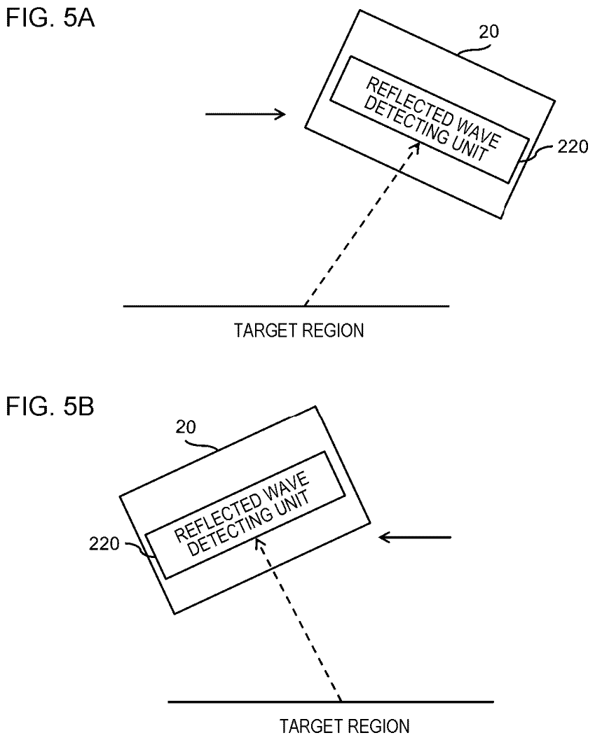

In the third example illustrated in FIGS. 5(A) and 5(B), the flying body 20 performs emission of an electromagnetic wave and detection of a reflected wave while moving. The flying body 20 is inclined while moving. The direction of this inclination with respect to the moving direction of the flying body 20 is substantially constant. Therefore, as illustrated in FIGS. 5(A) and 5(B), when the flying body 20 passes over the target region a plurality of times from different directions and performs emission of the electromagnetic wave and detection of the reflected wave every time it passes over the target region, the flying body can detect the reflected wave a plurality of times while differing the angle formed by the target region and the reflected wave detecting unit 220.

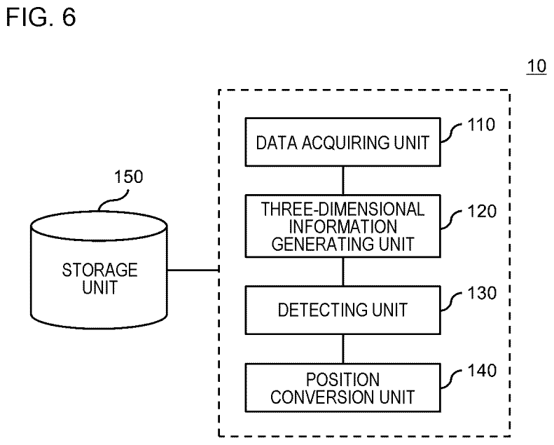

FIG. 6 is a diagram illustrating a detailed example of functions of the processing system 10. The processing system 10 includes the data acquiring unit 110, the three-dimensional information generating unit 120, the detecting unit 130, a position conversion unit 140, and the storage unit 150.

The data acquiring unit 110 acquires reflected wave data and position data generated by the flying body 20. The data acquiring unit 110 may acquire the reflected wave data and the position data from the flying body 20 via wireless communication, or may acquire the reflected wave data and the position data from the flying body 20 via a removable medium. Then, the data acquiring unit 110 stores the acquired data in the storage unit 150.

The three-dimensional information generating unit 120 generates three-dimensional information by processing the reflected wave data. Specifically, the reflected wave data includes a time-series signal of the intensity of the reflected wave. For example, the three-dimensional information generating unit 120 calculates the distance from the position where the reflected wave detecting unit 220 existed at the time of reflected wave detection to the reflection point that is the starting point of the reflected wave by processing the reflected wave data. The flying body 20 scans electromagnetic waves when generating reflected wave data. The distance described above is calculated with respect to each scanning direction of the electromagnetic wave.

Then, the three-dimensional information generating unit 120 specifies the distance calculated using each of the plurality of pieces of reflected wave data (however, angles formed by the target region and reflected wave detecting unit 220 are different from each other) corresponding to the same target region, and integrates these distances to estimate the position of at least one reflection point in the three-dimensional space. Furthermore, the three-dimensional information generating unit 120 calculates the intensity of the reflected wave corresponding to the reflection point by using the intensity of the reflected wave included in the reflected wave data. This intensity corresponds to the probability that an object exists at the reflection point. The three-dimensional information generating unit 120 generates three-dimensional information in this manner.

The detecting unit 130 detects the type of the object and the position of the object in a three-dimensional space by processing the three-dimensional information using a learned model. The explanatory variable of the learned model is the three-dimensional information, and the objective variable is the type of object and the position of the object in the three-dimensional space. The machine learning used in this learned model is, for example, deep learning such as GradCAM, but may be machine learning of other methods. The teacher data used for creating the learned model will be described later with reference to other figures. The position of the object detected here is based on the position of the flying body 20 when the reflected wave data serving as the basis of the three-dimensional information is generated, and is different from the position in the real space, that is, the position in the absolute coordinate system. Then, the detecting unit 130 stores the generated data in the storage unit 150.

The position conversion unit 140 specifies the position of the flying body 20 in the real space when the reflected wave data serving as the basis of the three-dimensional information is generated by using the position data acquired by the data acquiring unit 110. Then, using this position, the position conversion unit 140 converts the position of the object detected by the detecting unit 130 to a position in the real space. Then, the position conversion unit 140 stores the converted position in the storage unit 150.

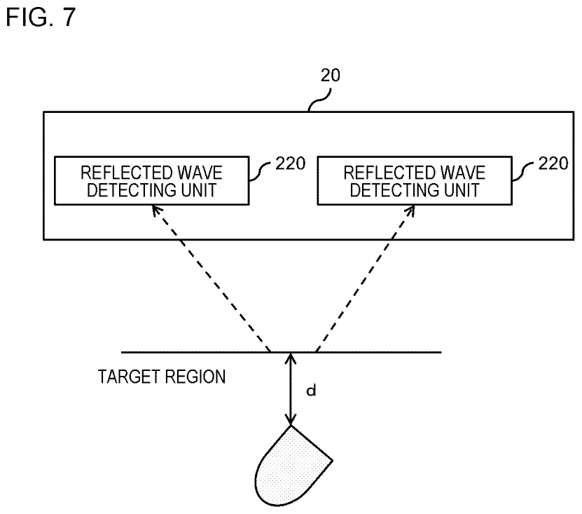

FIG. 7 is a diagram for describing a method for creating teacher data used when generating a learned model to be used by a detecting unit 130. This method is a method for generating teacher data for generating a learning model by performing processes described in the following (1) to (7) for each of a plurality of types of objects. The object used here may be an object itself to be detected by the object detection system, or may be an object imitating an outer shape of the object. In the latter case, at least the surface of the object used here is preferably made of metal.

(1) A depth d from the ground surface is set, and the object is disposed at the set depth d of the target region.

An object to be detected by the object detection system may be on the ground surface or may be buried in the ground. If the object is buried in the ground, the depth at which the object is buried varies. Therefore, the teacher data needs to be created while varying the depth at which the object is buried. Therefore, first, a depth d from the ground surface is set, and the object is disposed at the set depth d of the target region. d=0, that is, the object may be located on the ground surface.

(2) A measurement device including an electromagnetic wave emitting unit and a reflected wave detecting unit for detecting a reflected wave of an electromagnetic wave and generating reflected wave data is arranged above a target region.

An example of the measurement device is a flying body 20. However, the measuring device other than the flying body 20 may be used. In the latter case, the electromagnetic wave emitting unit and the reflected wave detecting unit included in the measurement device have functions similar to the electromagnetic wave emitting unit 210 and the reflected wave detecting unit 220, respectively. The height of the measurement device with reference to the ground surface of the target region is, for example, equal to or higher than 2 m and equal to or lower than 10 m. The range of the height preferably matches the range of the height from the ground surface when the flying body 20 generates the reflected wave data.

(3) The electromagnetic wave emitting unit of the measurement device emits the electromagnetic wave toward the object, and the reflected wave detecting unit of the measurement device generates the reflected wave data.

The reflected wave data generated here is similar to the reflected wave data generated by the flying body 20. (2) and (3) may be performed a plurality of times while varying the height of the measurement device. In this way, the teacher data corresponding to each of the plurality of heights can be created.

(4) The above (3) is executed a plurality of times while differing the angle formed by the target region and the reflected wave detecting unit.

When the reflected wave data is generated, the angle of the flying body 20 with respect to the object to be detected is not constant, and may vary depending on the inclination of the object and the relative position of the flying body 20 with respect to the object. Therefore, the teacher data needs to be created while differing the angle formed by the target region and the reflected wave detecting unit. As an example, any one of the methods described with reference to FIGS. 3, 4, and 5 is used. Then, according to (4), the teacher data corresponding to each of the plurality of angles can be created.

(5) The above (1), (2), (3), and (4) are performed a plurality of times while changing the set value of the depth d.

As a result, the teacher data corresponding to each of the plurality of depths d can be created.

(6) Three-dimensional information is generated for each of the plurality of depths d by processing the reflected wave data at a timing after (4).

The three-dimensional information is generated by using, for example, the three-dimensional information generating unit 120 of the processing system 10, and includes the position of the reflection point in the three-dimensional space and the probability that the object exists at that reflection point.

(7) The teacher data is generated with the three-dimensional information as the explanatory variable and the type and depth of the object as the objective variable.

The above (1) to (7) are performed for each type of object. Therefore, in the created teacher data, the three-dimensional information is used as an explanatory variable, and the type and depth of the object are used as objective variables.

Thereafter, a learned model is created by using the teacher data described above. This process is performed by using, for example, a learned model creating device. This creating device may be a part of the processing system 10, or may be a device different from the processing system 10. As a result, a learned model used by the detecting unit 130 of the processing system 10 is created. In this learned model, the three-dimensional information is used as an explanatory variable, and the type and depth of the object are used as objective variables.

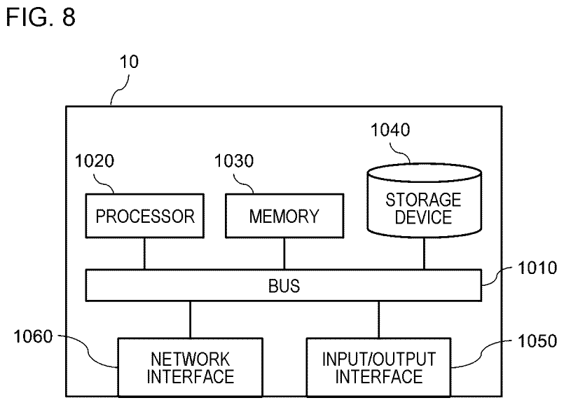

FIG. 8 is a diagram illustrating a hardware configuration example of a device constituting the processing system 10. As described above, the processing system 10 may be configured by one device or may be configured by a plurality of devices. Each of the devices constituting the processing system 10 includes a bus 1010, a processor 1020, a memory 1030, a storage device 1040, an input/output interface 1050, and a network interface 1060.

The bus 1010 is a data transmission path for the processor 1020, the memory 1030, the storage device 1040, the input/output interface 1050, and the network interface 1060 to transmit and receive data to and from each other. However, the method of connecting the processor and the like to each other is not limited to the bus connection.

The processor 1020 is a processor achieved by a central processing unit (CPU), a graphics processing unit (GPU), or the like

The memory 1030 is a main storage device achieved by a random access memory (RAM) or the like

The storage device 1040 is an auxiliary storage device achieved by a removable medium such as a hard disk drive (HDD), a solid state drive (SSD), and a memory card, or a read only memory (ROM), and has a recording medium. The recording medium of the storage device stores program modules that achieve each function (e.g., at least one of the data acquiring unit 110, the three-dimensional information generating unit 120, the detecting unit 130, and the position conversion unit 140) of the device. The processor 1020 reads and executes the program modules on the memory 1030, thereby implementing the functions corresponding to the program modules. Furthermore, the storage device 1040 also functions as the storage unit 150.

The input/output interface 1050 is an interface for connecting the device and various input/output devices.

The network interface 1060 is an interface for connecting the device to a network. The network is, for example, a local area network (LAN) or a wide area network (WAN). A method of connecting the network interface 1060 to the network may be a wireless connection or a wired connection. The device including the data acquiring unit 110 may communicate with the flying body 20 via the network interface 1060.

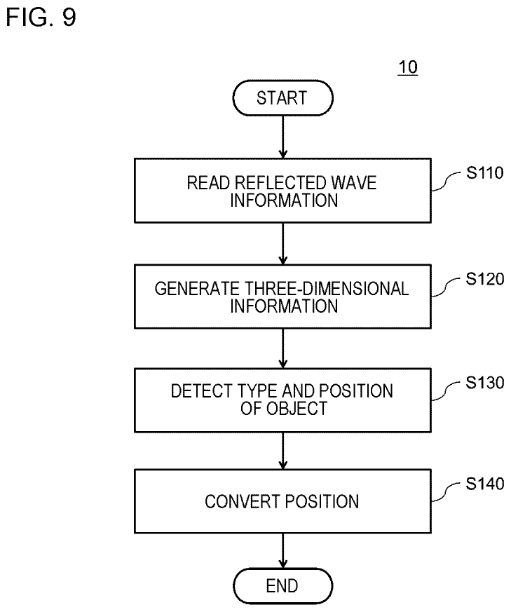

FIG. 9 is a flowchart illustrating an example of a process performed by the processing system 10. In the example illustrated in this figure, the processing system 10 performs the process in a batch manner

Apart from the process illustrated in the figure, the data acquiring unit 110 of the processing system 10 repeatedly acquires the reflected wave data and the position data from the flying body 20, and stores the data in the storage unit 150

First, the three-dimensional information generating unit 120 reads the reflected wave data from the storage unit 150 (step S110), and generates the three-dimensional information by processing the read reflected wave information (step S120). Next, the detecting unit 130 detects the type and position of the object by processing the three-dimensional information generated in step S120 (step S130). Then, the position conversion unit 140 converts the position detected in step S130 to a position in a real space (step S140).

As described above, according to the object detection system of the present example embodiment, the reflected wave data is generated by the flying body 20. Therefore, labor in generating the reflection data is reduced. In addition, the processing system 10 detects the type of the object and the position of the object in the three-dimensional space by processing the three-dimensional information with the learned model. Therefore, even if a large amount of noise is included in the reflected wave data, the type and position of the object can be accurately detected.

Furthermore, the position conversion unit 140 converts the position detected by the detecting unit 130 to a position in the real space. Therefore, the user of the object detection system can easily recognize the position of the object.

### First Modified Example

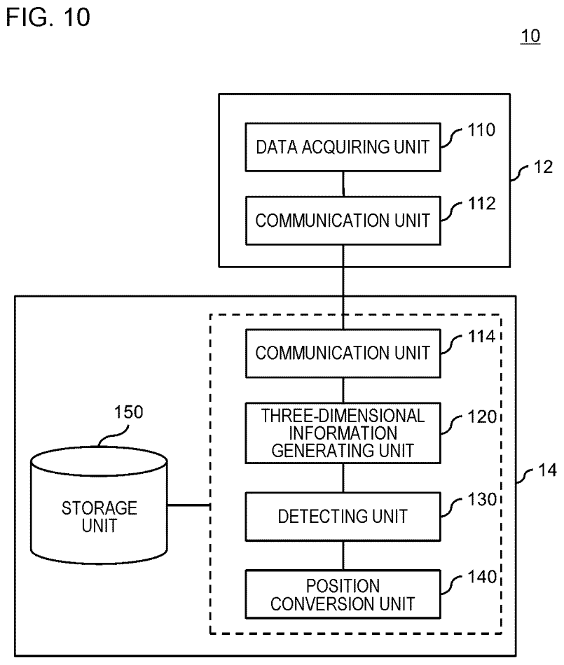

FIG. 10 is a diagram illustrating a configuration of the processing system 10 according to a first modified example. In the example illustrated in the figure, the processing system 10 includes a first device 12 and a second device 14. The first device 12 is, for example, a portable device, and is used near a target region, that is, on site. The second device 14 is, for example, a fixed cloud server, and is installed in a place different from the target region.

The first device 12 includes a data acquiring unit 110, and the second device 14 includes a three-dimensional information generating unit 120, a detecting unit 130, a position conversion unit 140, and a storage unit 150. The first device 12 further includes a communication unit 112, and the second device 14 further includes a communication unit 114. The communication unit 112, 114 is used when the first device 12 and the second device 14 communicate with each other. The communication between the first device 12 and the second device 14 may be performed, for example, via a public communication network such as the Internet.

According to the present modified example, the same effects as those of the example embodiment can be obtained. In addition, since the first device 12 is disposed on site, the processing system 10 can immediately acquire the reflected wave data and the position data generated by the flying body 20 and perform the process.

### Second Modified Example

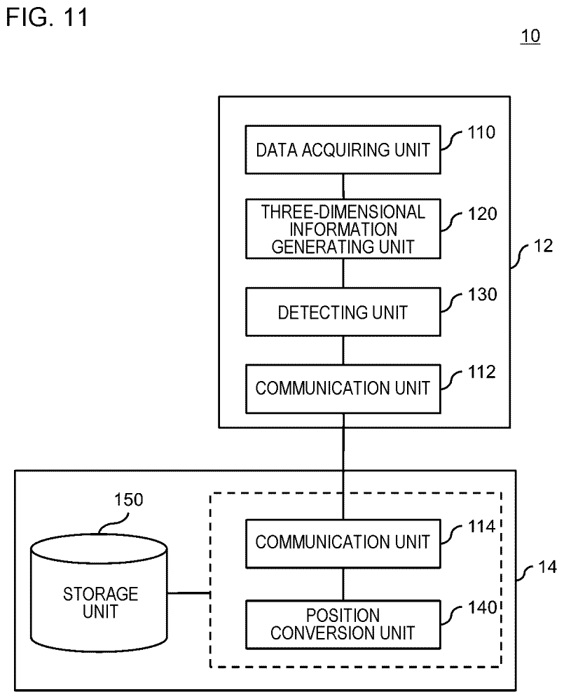

FIG. 11 is a diagram illustrating a configuration of the processing system 10 according to a first modified example. The example illustrated in the figure has a configuration similar to the processing system 10 illustrated in FIG. 10 except that the first device 12 includes the three-dimensional information generating unit 120 and the detecting unit 130, and the second device does not include the three-dimensional information generating unit 120 and the detecting unit 130. In the present modified example, an example of the first device 12 is a multi-access edge computing (MEC).

The first device 12 may not include the detecting unit 130. In this case, the second device 14 includes the detecting unit 130.

The first device 12 may further include the position conversion unit 140. In this case, the second device 14 is a device that stores various types of information in the storage unit 150.

According to the present modified example, the same effects as those of the example embodiment can be obtained. Furthermore, since the first device 12 includes the three-dimensional information generating unit 120 and the detecting unit 130, the reflected wave data and the position data do not need to be transmitted to the second device 14. Therefore, if the reflected wave data and the position data are not transmitted to second device 14, the amount of communication between first device 12 and second device 14 can be reduced.

Although the example embodiments of the present invention have been described above with reference to the drawings, these are examples of the present invention, and various configurations other than the above can be adopted.

In addition, in the flowchart used in the above description, a plurality of steps (processes) are described in order, but the execution order of the steps executed in each example embodiment is not limited to the described order. In each example embodiment, the order of the illustrated steps can be changed within a range in which problems do not arise in terms of content. Furthermore, the example embodiments described above can be combined within a range in which the contents are not contradictory.

Some or all of the example embodiments described above may be described as the following Supplementary Notes, but are not limited to the following.

1. An object detection system for detecting an object existing on a ground surface or in a ground of a target region, the object detection system including:
a flying body and a processing system, in which
the flying body includes
   an electromagnetic wave emitting means for emitting an electromagnetic wave toward the target region, and
   a reflected wave detecting means for detecting a reflected wave of the electromagnetic wave and generating reflected wave data, and
the processing system includes
   a data acquiring means for acquiring the reflected wave data,
   a three-dimensional information generation means for generating three-dimensional information including a position of a reflection point in a three-dimensional space and a probability that an object exists at the reflection point by using the reflected wave data, and
   a detecting means for detecting a type of the object and a position in the three-dimensional space by processing the three-dimensional information with a learned model.

2. The object detection system according to the above 1, in which
the flying body further includes a position detecting means for generating position data indicating a position of the flying body,
the data acquiring means further acquires the position data, and
the processing system further includes a position conversion means for converting a position of the object in the three-dimensional space to a position in a real space by using the position data.

3. The object detection system according to the above 1 or 2, in which
the processing system includes
   a first device including the data acquiring means, and
   a second device including the three-dimensional information generation means and the detecting means, and
the data acquiring means acquires the reflected wave data from the flying body via wireless communication.

4. The object detection system according to any one of the 1 to 3, in which
the processing system includes
   a first device including the data acquiring means, the three-dimensional
   information generation means, and the detecting means, and a second device for storing a detection result of the detecting means.

5. The object detection system according to any one of the above 1 to 4, in which
the reflected wave detecting means detects the reflected wave a plurality of times while differing an angle formed by the target region and the reflected wave detecting means when generating the reflected wave data.

6. The object detection system according to any one of the above 1 to 5, in which
a frequency of the electromagnetic wave is equal to or more than 0.3 GHz and equal to or less than 300 GHz.

7. A processing system for detecting an object existing on a ground surface or in a ground of a target region, the processing system including:
a data acquiring means for acquiring, from a flying body including an electromagnetic wave emitting means for emitting an electromagnetic wave toward the target region, and a reflected wave detecting means for detecting a reflected wave of the electromagnetic wave and generating reflected wave data, the reflected wave data,
a three-dimensional information generation means for generating three-dimensional information including a position of a reflection point in a three-dimensional space and a probability that an object exists at the reflection point by using the reflected wave data, and
a detecting means for detecting a type of the object and a position in the three-dimensional space by processing the three-dimensional information with a learned model.

8. A teacher data generating method for generating teacher data for generating a learning model by performing processes described in the following (1) to (7) on each of a plurality of types of objects.
(1) A depth from a ground surface is set, and the object is disposed at the set depth of a target region.
(2) A measurement device including an electromagnetic wave emitting means for emitting an electromagnetic wave and a reflected wave detecting means for detecting a reflected wave of the electromagnetic wave and generating reflected wave data is arranged above the target region.
(3) The electromagnetic wave is emitted toward the object from the electromagnetic wave emitting means, and the reflected wave detecting means is caused to generate the reflected wave data.
(4) The (3) is executed a plurality of times while differing an angle formed by the target region and the reflected wave detecting means.
(5) The (1), (2), (3), and (4) are performed a plurality of times while changing a set value of the depth.
(6) Three-dimensional information including a position of a reflection point in a three-dimensional space and a probability that an object exists at the reflection point is generated for each of the depth by processing the reflected wave data at a timing after the (4).
(7) The teacher data is generated with the three-dimensional information as an explanatory variable and the type and the depth of the object as objective variables.

9. The teacher data generating method according to the above 8, further including:
generating, by using the teacher data, a learned model having the three-dimensional information as an explanatory variable and the type and the depth of the object as objective variables.

10. An object detection method for detecting an object existing on a ground surface or in a ground of a target region, in which
the flying body,
emits an electromagnetic wave toward the target region and detects a reflected wave of the electromagnetic wave to generate reflected wave data, and
the processing system,
acquires the reflected wave data, and by using the reflected wave data, generates three-dimensional information including a position of a reflection point in a three-dimensional space and a probability that an object exists at the reflection point, and
detects a type of the object and a position in the three-dimensional space by processing the three-dimensional information with a learned model.

11. The object detection method according to the above 10, in which
the flying body further generates position data indicating a position of the flying body, and
the processing system further,
   acquires the position data, and
   converts a position of the object in the three-dimensional space to a position in a real space using the position data.

12. The object detection method according to the above 10 or 11, in which
the processing system includes
   a first device for acquiring the reflected wave data from the flying body via wireless communication, and
   a second device for generating the three-dimensional information and detecting a type of the object and a position in the three-dimensional space.

13. The object detection method according to any one of the above 10 to 12, in which
the processing system includes
   a first device for acquiring the reflected wave data from the flying body, generating the three-dimensional information, and detecting a type of the object and a position in the three-dimensional space, and
   a second device for storing a type of the object and a position in the three-dimensional space.

14. The object detection method according to any one of the above 10 to 13, in which
the flying body detects the reflected wave a plurality of times while differing an angle formed by the target region and the reflected wave detecting means when generating the reflected wave data.

15. The object detection method according to any one of the above 10 to 14, in which
a frequency of the electromagnetic wave is equal to or more than 0.3 GHz and equal to or less than 300 GHz.

16. A program for causing a computer to:
acquire, from a flying body including an electromagnetic wave emitting means for emitting an electromagnetic wave toward a target region, and a reflected wave detecting means for detecting a reflected wave of the electromagnetic wave and generating reflected wave data, the reflected wave data,
generate three-dimensional information including a position of a reflection point in a three-dimensional space and a probability that an object exists at the reflection point by using the reflected wave data, and
detecting a type of the object and a position in the three-dimensional space by processing the three-dimensional information with a learned model.

17. The program according to the above 16, in which
the flying body further generates position data indicating a position of the flying body, and
the computer is further caused to
   acquire the position data, and
   convert a position of the object in the three-dimensional space to a position in a real space using the position data.

18. The program according to the above 16 or 17, in which
a frequency of the electromagnetic wave is equal to or more than 0.3 GHz and equal to or less than 300 GHz.

19. A recording medium recorded with the program according to any one of the above to 18.

This application is based upon and claims the benefit of priority from Japanese Patent Application No. 2023-055109, filed on Mar. 30, 2023, the disclosure of which is incorporated herein in its entirety by reference.

### REFERENCE SIGNS LIST

10 processing system
20 flying body
110 data acquiring unit
120 three-dimensional information generating unit
130 detecting unit
140 position conversion unit
150 storage unit
210 electromagnetic wave emitting unit
220 reflected wave detecting unit
230 position detecting unit
240 output unit

1.-6. (canceled)

7. A processing system for detecting an object existing on a ground surface or in a ground of a target region, the processing system comprising:
at least one memory storing instructions; and
at least one processor configured to execute the instructions to:
acquire, from a flying body comprising an electromagnetic wave emitting unit that emits an electromagnetic wave toward the target region, and a reflected wave detecting unit that detects a reflected wave of the electromagnetic wave and generates reflected wave data, the reflected wave data;
generate three-dimensional information including a position of a reflection point in a three-dimensional space and a probability that an object exists at the reflection point by using the reflected wave data; and
detect a type of the object and a position in the three-dimensional space by processing the three-dimensional information with a learned model.

8. A teacher data generating method comprising:
for each of a plurality of types of objects,
emitting an electromagnetic wave to an object from above a target region where the object is disposed at a predetermined depth from a ground surface;
generating reflected wave data by detecting a reflected wave of the electromagnetic wave while changing an angle between a reflected wave detecting unit that detects the reflected wave and the target region;
generating, for each of a plurality of depths, three-dimensional information including a position of a reflection point in a three-dimensional space and a probability that the object exists at the reflection point based on the reflected wave data; and
generating teacher data with the three-dimensional information as an explanatory variable and the type and the depth of the object as objective variables.

9. The teacher data generating method according to claim 8, further comprising:
generating, by using the teacher data, a learned model having the three-dimensional information as an explanatory variable and the type and the depth of the object as objective variables.

10. An object detection method, executed by a processing system, comprising:
acquiring the reflected wave data from a flying body comprising an electromagnetic wave emitting unit that emits an electromagnetic wave toward the target region and a reflected wave detecting unit that detects a reflected wave of the electromagnetic wave and generates the reflected wave data;
generating three-dimensional information including a position of a reflection point in a three-dimensional space and a probability that an object exists at the reflection point by using the reflected wave data; and
detecting a type of the object and a position in the three-dimensional space by processing the three-dimensional information with a learned model.

11. The object detection method according to claim 10, wherein
the flying body further generates position data indicating a position of the flying body, and
the method further comprising
acquiring the position data, and
converting a position of the object in the three-dimensional space to a position in a real space using the position data.

12. The object detection method according to claim 10, wherein
the processing system comprises a first device and a second device,
the first device acquires the reflected wave data from the flying body via wireless communication, and
the second device generates the three-dimensional information and detects a type of the object and a position in the three-dimensional space.

13. The object detection method according to claim 10, wherein
the processing system comprises a first device and a second device,
the first device acquires the reflected wave data from the flying body, generating the three-dimensional information, and detects a type of the object and a position in the three-dimensional space, and
the second device stores a type of the object and a position in the three-dimensional space.

14. The object detection method according to claim 10, wherein
the flying body detects the reflected wave a plurality of times while differing an angle with respect to the target region when generating the reflected wave data.

15. The object detection method according to claim 10, wherein
a frequency of the electromagnetic wave is equal to or more than 0.3 GHZ and equal to or less than 300 GHz.

16.-18. (canceled)

19. The processing system according to claim 7, wherein
the flying body further comprises a position detecting unit that generates position data indicating a position of the flying body,
the at least one processor is further configured to execute the instructions to:
acquire the position data; and
convert a position of the object in the three-dimensional space to a position in a real space using the position data.

20. The processing system according to claim 7, wherein
the processing system comprises a first device and a second device,
the first device acquires the reflected wave data from the flying body via wireless communication, and
the second device generates the three-dimensional information and detects the type of the object and the position in the three-dimensional space by processing the three-dimensional information with the learned model.

21. The processing system according to claim 7, wherein
the processing system comprises a first device and a second device,
the first device acquires the reflected wave data, generates the three-the three-dimensional information, and detects the type of the object and the position in the three-dimensional space by processing the three-dimensional information with the learned model, and
the second device stores the type of the object and the position in the three-dimensional space detected by the first device.

22. The processing system according to claim 7, wherein
the reflected wave detecting unit detects the reflected wave a plurality of times while differing an angle with respect to the target region when generating the reflected wave data.

23. The processing system according to claim 7, wherein
a frequency of the electromagnetic wave is equal to or more than 0.3 GHZ and equal to or less than 300 GHz.
